(19) United States
(12) Patent Application Publication
(10) Pub. No.: US 2014/0204468 A1
(43) Pub. Date: Jul. 24, 2014

(54) LENS AND PROJECTOR

(71) Applicant: BOE TECHNOLOGY GROUP CO., LTD., Beijing (CN)

(72) Inventors: Juan Chen, Beijing (CN); Jaegeon You, Beijing (CN)

(73) Assignee: BOE TECHNOLOGY GROUP CO., LTD., Beijing (CN)

(21) Appl. No.: 13/703,534

(22) PCT Filed: Oct. 17, 2012
(86) PCT No.: PCT/CN2012/083084

§ 371 Date: Dec. 11, 2012

(30) Foreign Application Priority Data
Dec. 20, 2011 (CN) 201120537297.7

(51) Int. Cl. G02B 3/12

(52) U.S. Cl. CPC G02B 3/12
USPC 359/665

(57) ABSTRACT

The present invention provides a lens and a projector having the same lens. The lens comprises: a lower substrate, an upper substrate opposite to the lower substrate, and a common electrode located at a lower side of the upper substrate, wherein the lower substrate is formed thereon with at least two electrode groups; moreover, between the common electrode and the electrode groups, there is provided with lens liquid, and the lens liquid is composed of hydrophilic liquid and oleophilic liquid. With the use of such lens, a small portable projector with an adjustable projection range can be achieved.

### TECHNICAL FIELD

The present invention relates to a lens and a projector.

### BACKGROUND

A traditional projector uses ordinary solid lenses to obtain a desired projection function.

In the process of achieving the above technical solution, there exist the following problems: since an existing projector is made with an ordinary solid lens, the projector requires a lens having a relatively large area to obtain the desired projection area and effect, which results in a relatively heavy and bulky product which is inconvenient to carry, and it is not able to achieve up-and-down and left-and-right movement of the projection range of the lens.

### SUMMARY

In order to at least partially solve the above problems in the related art, the embodiments of the present invention provide a lens and a projector having the same lens.

The lens comprises: a lower substrate, an upper substrate opposite to the lower substrate, and a common electrode located at a lower side of the upper substrate, wherein the lower substrate is formed thereon with at least two electrode groups; between the common electrode and the electrode groups, there is provided with lens liquid, and the lens liquid is composed of hydrophilic liquid and oleophilic liquid.

In some examples, the hydrophilic liquid in the lens liquid is formed on the oleophilic liquid.

Preferably, between the lens liquid and at least one of the common electrode and the electrode groups, there is provided with an insulating layer.

The at least two electrode groups may comprise a first electrode group and a second electrode group.

Preferably, the first electrode group and the second electrode group are provided symmetrically on the lower substrate.

The first electrode group and the second electrode group may each comprise one electrode.

Preferably, the first electrode group and the second electrode group may each comprise at least two electrodes.

Preferably, in the at least two electrodes comprised in at least one from the first and second electrode groups, adjacent electrodes are equally spaced.

A projector according to an embodiment of the present invention comprises a lens with a configuration as described above.

### BRIEF DESCRIPTION OF THE DRAWINGS

In order to clearly illustrate the technical solutions in the embodiments of the invention or in the prior art, the drawings needed in the description of the embodiments or the prior art will be briefly described in the following; it is obvious that the described drawings are only related to some embodiments. Based on these accompanying drawings, those skilled in the art can obtain other drawing(s), without any inventive work.

FIG. 1 is a schematic structural diagram of a lens provided by an embodiment of the present invention;

FIG. 2 is a first schematic diagram of an electrode structure of a lens provided by an embodiment of the present invention;

FIG. 3 is a second schematic diagram of an electrode structure of a lens provided by an embodiment of the present invention;

FIG. 4 is a third schematic diagram of an electrode structure of a lens provided by an embodiment of the present invention;

FIG. 5 is a fourth schematic diagram of an electrode structure of a lens provided by an embodiment of the present invention;

FIG. 6 is a fifth schematic diagram of an electrode structure of a lens provided by an embodiment of the present invention;

FIG. 7 is a first schematic structural diagram of a lens provide by an embodiment of the present invention, after power is supplied;

FIG. 8 is a second schematic structural diagram of a lens provide by an embodiment of the present invention, after power is supplied;

FIG. 9 is a third schematic structural diagram of a lens provide by an embodiment of the present invention, after power is supplied;

FIG. 10 is a fourth schematic structural diagram of a lens provide by an embodiment of the present invention, after power is supplied;

FIG. 11 is a fifth schematic structural diagram of a lens provide by an embodiment of the present invention, after power is supplied;

FIG. 12 is a first schematic diagram of a projector provided by an embodiment of the present invention, based on the lens shown in FIG. 7;

FIG. 13 is a second schematic diagram of a projector provided by an embodiment of the present invention, based on the lens shown in FIG. 8.

### DETAILED DESCRIPTION OF THE PREFERRED EMBODIMENTS

The technical solutions in the embodiments of the invention will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

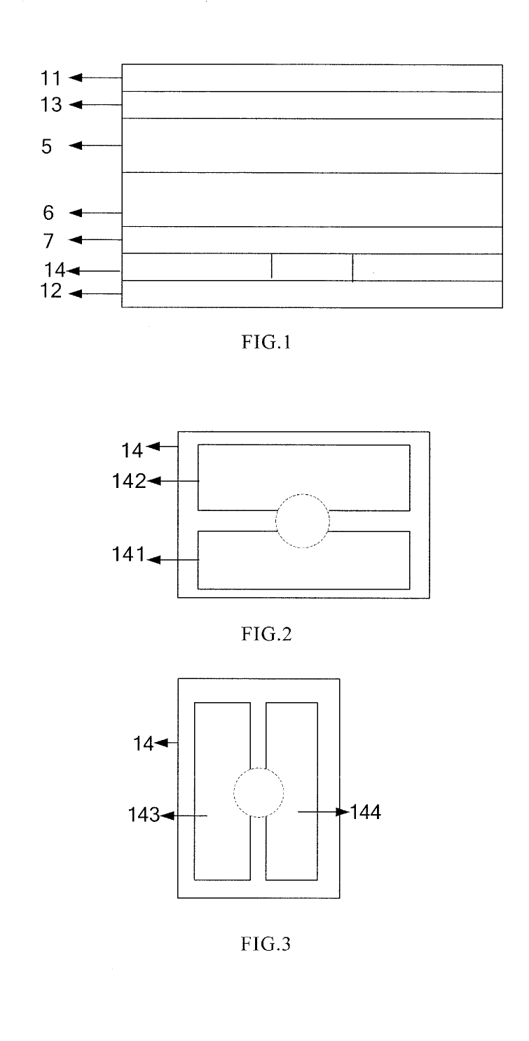

An embodiment of the present invention provides a lens 1, as shown in FIG. 1, the basic structure of which comprises: a lower substrate 12, an upper substrate 11 opposite to the lower substrate 12, and a common electrode 13 located at a lower side of the upper substrate 11. The lower substrate 12 is formed thereon with an electrode group 14. Between the common electrode 13 and the electrode group 14, there is provided with lens liquid, and the lens liquid is composed of hydrophilic liquid 5 and oleophilic liquid 6.

In the example shown in FIG. 1, the electrode group 14 comprises a first electrode group and a second electrode group. The first electrode group and the second electrode group are formed with an insulating layer 7 thereon, and the oleophilic liquid 6 is located on the insulating layer 7, and the hydrophilic liquid 5 is located on the oleophilic liquid 6, and the common electrode 13 is located on the top of the hydrophilic liquid 5.

However, it should be noted that, the insulating layer 7 is not always necessary. In the case that the electrodes in the electrode group are mutually and finely insulated through separation, the insulating layer 7 may be omitted. Further, in order to prevent the liquid from being ionized, the insulating layer 7 also may be retained, and an additional insulating layer is provided between the common electrode 13 and the liquid.

In addition, the arrangement position of the oleophilic liquid 6 and the hydrophilic liquid 5 also may be exchanged. That is, the oleophilic liquid 6 may be formed closer to the common electrode 13 than the hydrophilic liquid 5.

Preferably, the two electrode groups, i.e., the first electrode group and the second electrode group formed on the lower substrate, are provided symmetrically on the substrate.

Thus, the lower substrate 12 is formed thereon with the first electrode group and the second electrode group, and the two electrode groups 14 are provided symmetrically on the substrate. By applying different or equal voltages to the two electrode groups 14 provided symmetrically on the lower substrate 12, the oleophilic liquid 6 is made to present different shapes to achieve movement of the projection range and position. Due to the different shapes of the water-oil lens, light deflection directions in respective regions are different, which can achieve a function of a large-area projection with a small-area lens.

Preferably, the first electrode group comprises at least two electrodes, and the second electrode group comprises at least two electrodes. In this way, the lens 1 can have more accurate deformation and/or movement. More preferably, adjacent electrodes comprised in the first electrode group or in the second electrode group are equally spaced. Thus, it is possible to make a relatively uniform distribution of the electric field between the electrodes. and a better control of the shape of the lens; with the effective control of the shape of the lens, it is thus possible to better achieve a function of a large-area projection with a small-area lens.

It should be noted that, the present invention is not limited to the case that the adjacent electrodes comprised in the first electrode group or in the second electrode group are equally spaced. For example, it is possible that the adjacent electrodes comprised in the first electrode group are equally spaced, while the adjacent electrodes comprised in the second electrode group are differently spaced; or, the adjacent electrodes comprised in the second electrode group are equally spaced, while the adjacent electrodes comprised in the first electrode group are differently spaced; or, the adjacent electrodes comprised in the first electrode group or in the second electrode group are all differently spaced.

Below, an exemplary description is given to the first electrode group and the second electrode group provided in the lens with reference to FIGS. 2-5. However, the embodiments of the present invention are not limited to this; instead, other structures of electrode groups as well as number of electrodes also may be possible.

In the example shown in FIG. 2, in the two electrode groups 14 of the lens 1, the first electrode group comprises one electrode 141, and the second electrode group comprises one electrode 142. The first electrode 141 and the second electrode 142 are arranged from the top down side by side in a same plane. In this way, with power supply being supplied, it is possible to make the oleophilic liquid 6 and the hydrophilic liquid 5 present a shape which is offset upward or downward, so that the lens 1 can achieve an up-and-down movement of the projection range during projection.

In another example shown in FIG. 3, in the two electrode groups 14 of the lens 1, the first electrode group comprises one electrode 143, and the second electrode group comprises one electrode 144. The first electrode 143 and the second electrode 144 are arranged from left to right side by side in a same plane. In this way, with power supply being supplied, it is possible to make the oleophilic liquid 6 and the hydrophilic liquid 5 present a shape which is offset to the left or to the right, so that the lens 1 can achieve a left-and-right movement of the projection range during projection.

In another example shown in FIG. 4, each of the first electrode group and the second electrode group in the two electrode groups 14 of the lens 1 comprise two electrodes. As shown in FIG. 4, the two electrodes 1411, 1412 of the first electrode group and the two electrodes 1421, 1422 of the second electrode group are arranged in a same plane in the lower left, lower right, upper left, and upper right, respectively. This helps the lens 1 to realize an up, down, left and right movement of the projection range and position.

In another example shown in FIG. 5, each of the first electrode group and the second electrode group in the two electrode groups 14 of the lens 1 comprise three electrodes. As shown in FIG. 5, the first electrode group and the second electrode group are located in a same plane at an upper side and a lower side, respectively; the three electrodes 1411, 1412, 1413 of the first electrode group 141 and the three electrodes 1422, 1421, 1423 of the second electrode group 142 are arranged side by side in a left-to-right direction on the screen, respectively. Thus, it is possible to accurately realize a lens with an up, down, left and right movement of the projection range and position.

It should be noted that, the present invention is not limited in the number of electrodes comprised in the first and second electrode groups. For example, each of the first electrode group and the second electrode group may comprise more than three electrodes. Or, the first electrode group and the second electrode group may comprise a different number of electrodes.

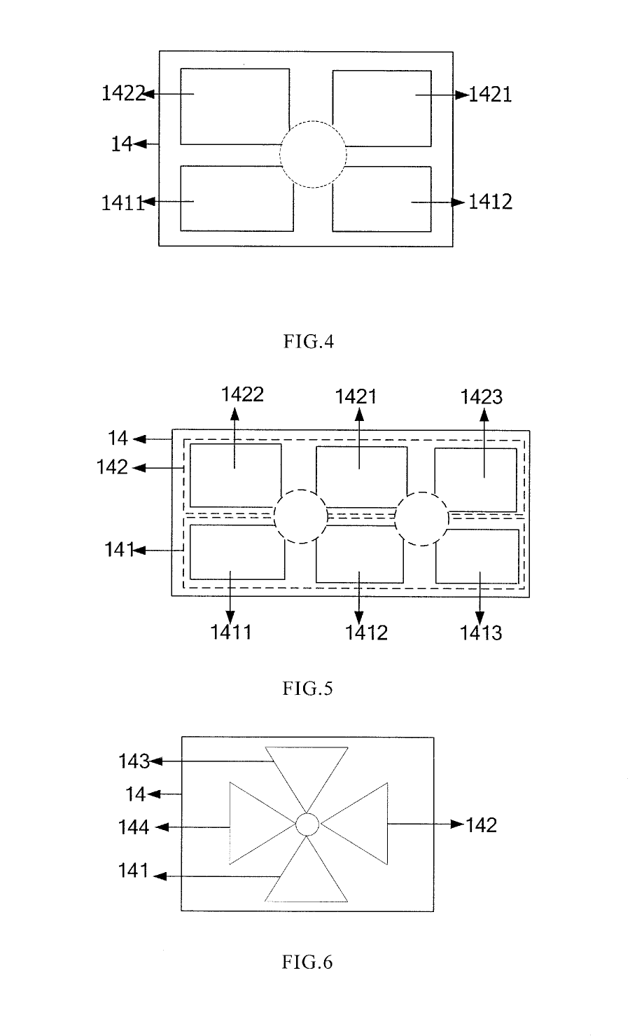

It should be noted that, although in the above-illustrated examples, the electrodes are shown as in a rectangular shape, but the present invention is not limited in this respect. For example, the electrodes may use an electrode shape and arrangement as shown in FIG. 6.

The skilled in the art can easily conceive other variations or alternatives on the basis of the various structures of the electrode groups disclosed by the embodiments of the present invention, and the obtained structures of electrodes should also fall into the scope of the present invention.

The electrodes may be produced from a same material, also may be evenly divided into two regions and produced from different impedance materials. An insulating material or a high-impedance material can be added between the electrodes for isolation, so that the electric field between the electrodes is relatively uniformly distributed, so that the water-oil lens achieves a precise offset.

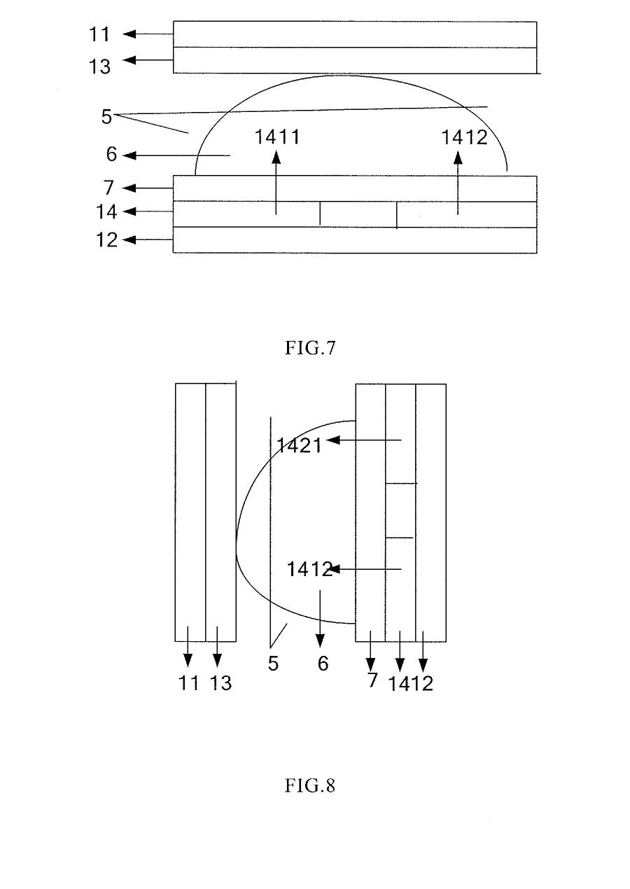

Below, with reference to FIGS. 7-11, with the case shown in FIG. 4 as an example, in which the first electrode group comprises two electrodes 1411, 1412 and the second electrode group comprises two electrodes 1421, 1422, a description is given to a variety of lens formed by the oleophilic liquid 6 under the control of the electrode groups after power is supplied. By applying different voltages to the electrodes in the first electrode group and in the second electrode group, it is possible to control the shape of the oleophilic liquid 6 at different regions, so that the oleophilic liquid at different regions have different light refraction directions, and eventually make the overall oleophilic liquid 6 form a variety of symmetrical or asymmetrical lens.

As shown in FIG. 7, in the case that the four electrodes are applied with equal voltages, the overall oleophilic liquid presents a symmetrical lens.

FIG. 8 shows a lens formed in the case that the electrode 1411 and the electrode 1412 are applied with equal voltages, while the electrode 1421 and the electrode 1422 are applied with equal voltages which are greater than the voltages applied to the electrode 1411 and the electrode 1412. As shown in FIG. 8, in this case, a lens is formed with an offset toward the electrode 1411 and the electrode 1412 (toward the lower side in FIG. 4).

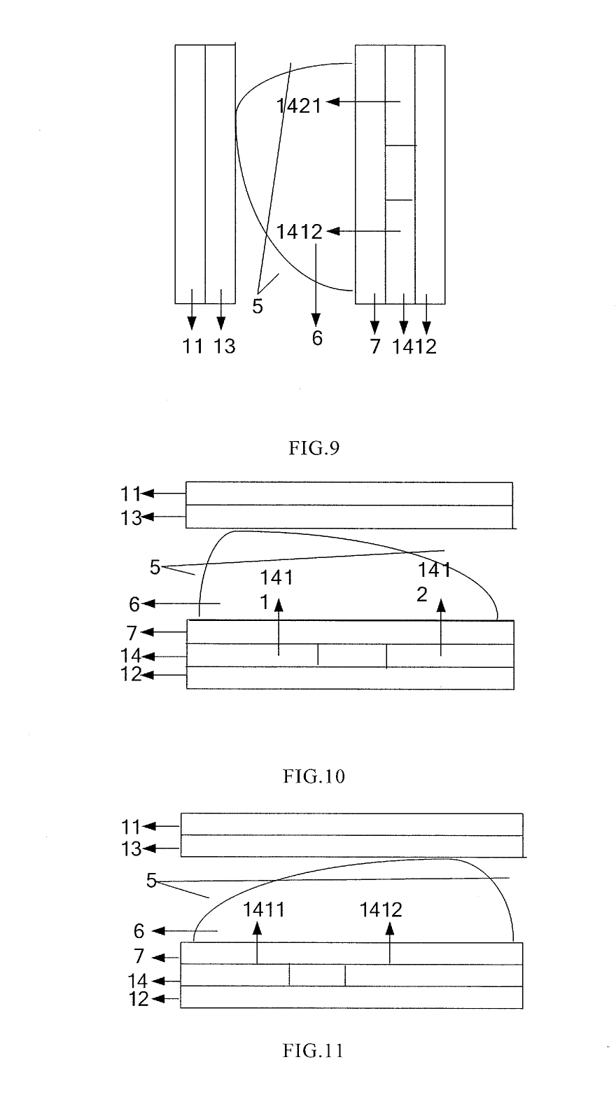

FIG. 9 shows a lens formed in the case that the electrode 1411 and the electrode 1412 are applied with equal voltages, while the electrode 1421 and the electrode 1422 are applied with equal voltages which are less than the voltages applied to the electrode 1411 and the electrode 1412. As shown in FIG. 9, in this case, a lens is formed with an offset toward the electrode 1421 and the electrode 1422 (toward the upper side in FIG. 4).

FIG. 10 shows a lens formed in the case that the electrode 1411 and the electrode 1422 are applied with equal voltages, while the electrode 1421 and the electrode 1412 are applied with equal voltages which are greater than the voltages applied to the electrode 1411 and the electrode 1422. As shown in FIG. 10, in this case, a lens is formed with an offset toward the electrode 1411 and the electrode 1422 (toward the left side in FIG. 4).

FIG. 11 shows a lens formed in the case that the electrode 1411 and the electrode 1422 are applied with equal voltages, while the electrode 1421 and the electrode 1412 are applied with equal voltages which are less than the voltages applied to the electrode 1411 and the electrode 1422. As shown in FIG. 11, in this case, a lens is formed with an offset toward the electrode 1421 and the electrode 1412 (toward the right side in FIG. 4).

It should be noted that, the magnitudes of the voltages applied to the respective electrodes can be adjusted according to the needs of an actual projection. When the lens is symmetrical, it mainly depends on the surface curvature differences to control light convergence; when the lens is asymmetrical, the surface curvature will change, and light will be transformed in its refraction direction after passing through the lens, and the light refraction scope of the lens is controlled in this way.

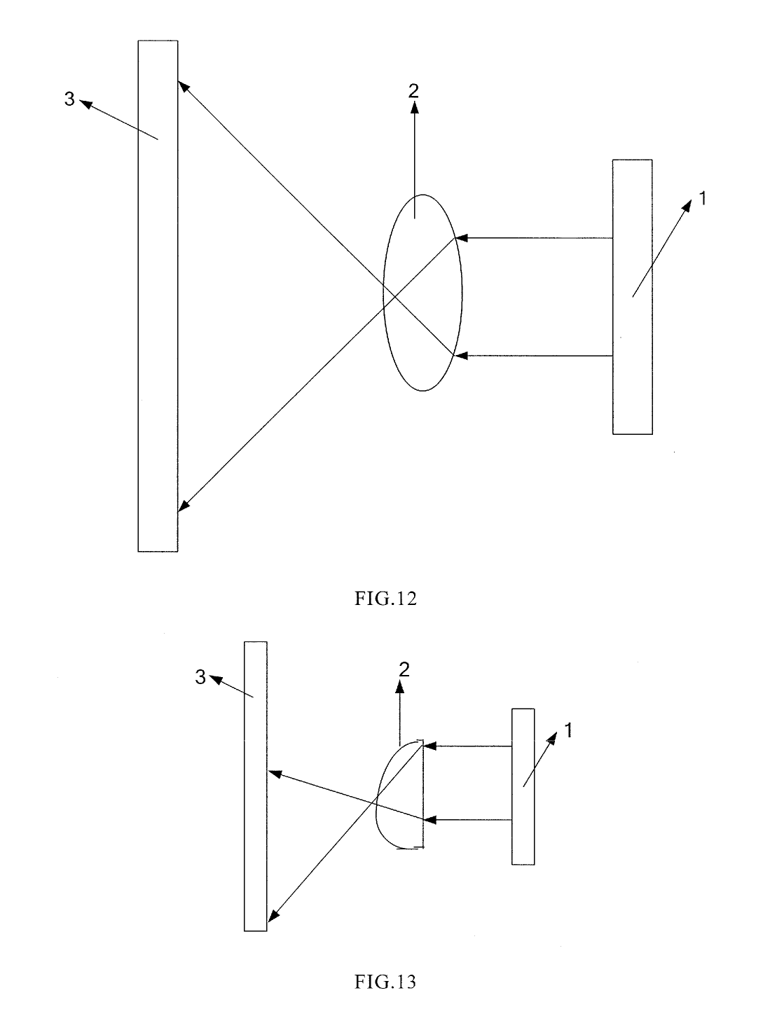

According to other embodiments of the present invention, there is also provided a projector, and the projector uses a lens as described above. Below, with reference to FIG. 12 and FIG. 13, a description is given to the changes of projection from a projector obtained by using a lens as shown in FIG. 7 and FIG. 8, respectively.

FIG. 12 is a schematic diagram of a projection when the lens in the projector is in a state as shown in FIG. 7. As shown in FIG. 12, light from a light source 1 is projected through a lens 2 to a screen 3, and because the lens shown in FIG. 7 is in a symmetrical state, the light is centrally projected onto the screen.

FIG. 13 is a schematic diagram of a projection when the lens in the projector is in a state as shown in FIG. 8. As shown in FIG. 13, the light from the light source 1 is projected through the lens 2 onto the screen 3, and because the lens shown in FIG. 8 is in a state offset to one side (offset toward the electrode 1411 and the electrode 412, that is, offset toward the lower side in FIG. 4), the projection is also shifted to that one side.

It can be understood that, as similar to the illustration in FIG. 13, the projections from the projectors based on the lens shown in FIGS. 9-11 are also shifted, with the only difference lying in the different shift directions. Hence, it will not be repeatedly described here.

The embodiment of the present invention provides a projector, in which different shapes of the lens are achieved through the control of the voltages to the electrode groups of the lens, and because the different shapes of the lens at various regions have different light deflection directions, it can achieve a large-area projection with a small-area lens, and realize an ideal projection effect, and further it can be made into a small portable projector.

Although in the above description and drawings, the number of electrode groups on the lower substrate 12 is two, it should be understood that, the embodiments of the invention are not limited to such case that the number of electrode groups is two, and the number of electrode groups may be more than two. With the increase in the number of the electrode groups, the lens can achieve a more fine adjustment of its shape and position.

The above description is merely specific implementation of the present invention, and the scope of the present invention is not limited thereto. Within the technical scope disclosed by the present invention, modifications or replacements which can be easily conceived by those skilled in the art who are familiar with the technical field, all should be included within the scope of the invention. Accordingly, the scope of the invention should be defined by the scope of the claims of the present invention.

1. A lens comprising: a lower substrate, an upper substrate opposite to the lower substrate, and a common electrode located at a lower side of the upper substrate, wherein
the lower substrate is formed thereon with at least two electrode groups; and
between the common electrode and the electrode groups, there is provided with lens liquid, and the lens liquid is composed of hydrophilic liquid and oleophilic liquid.

2. The lens according to claim 1, wherein the hydrophilic liquid in the lens liquid is formed on the oleophilic liquid.

3. The lens according to claim 1, wherein between the lens liquid and at least one of the common electrode and the electrode groups, there is provided with an insulating layer.

4. The lens according to claim 2, wherein between the lens liquid and at least one of the common electrode and the electrode groups, there is provided with an insulating layer.

5. The lens according to claim 1, wherein the at least two electrode groups comprise a first electrode group and a second electrode group.

6. The lens according to claim 5, wherein the first electrode group and the second electrode group are provided symmetrically on the lower substrate.

7. The lens according to claim 1, wherein
the first electrode group and the second electrode group each comprise one electrode.

8. The lens according to claim 1, wherein the first electrode group and the second electrode group each comprise at least two electrodes.

9. The lens according to claim 8, wherein, in the at least two electrodes comprised in the first electrode group, adjacent electrodes are equally spaced.

10. The lens according to claim 8, wherein, in the at least two electrodes comprised in the second electrode group, adjacent electrodes are equally spaced.

11. A projector comprising a lens, wherein
the lens comprises: a lower substrate, an upper substrate opposite to the lower substrate, and a common electrode located at a lower side of the upper substrate, wherein the lower substrate is formed thereon with at least two electrode groups; between the common electrode and the electrode groups, there is provided with lens liquid, and the lens liquid is composed of hydrophilic liquid and oleophilic liquid.

12. The projector according to claim 11, wherein the hydrophilic liquid in the lens liquid is formed on the oleophilic liquid.

13. The projector according to claim 11, wherein between the lens liquid and at least one of the common electrode and the electrode groups, there is provided with an insulating layer.

14. The projector according to claim 12, wherein between the lens liquid and at least one of the common electrode and the electrode groups, there is provided with an insulating layer.

15. The projector according to claim 11, wherein the at least two electrode groups comprise a first electrode group and a second electrode group.

16. The projector according to claim 15, wherein the first electrode group and the second electrode group are provided symmetrically on the lower substrate.

17. The projector according to claim 11, wherein
the first electrode group and the second electrode group each comprise one electrode.

18. The projector according to claim 11, wherein the first electrode group and the second electrode group each comprise at least two electrodes.

19. The projector according to claim 18, wherein in the at least two electrodes comprised in the first electrode group, adjacent electrodes are equally spaced.

20. The projector according to claim 18, wherein in the at least two electrodes comprised in the second electrode group, adjacent electrodes are equally spaced.
